(19) United States
(12) Patent Application Publication
(10) Pub. No.: US 2015/0288074 A1
(43) Pub. Date: Oct. 8, 2015

(54) SAR REDUCTION IN RADIO TRANSMITTING DEVICES

(71) Applicant: MICROSOFT CORPORATION, Redmond, WA (US)

(72) Inventors: Marc Harper, Issaquah, WA (US); Devis Iellici, Cambridge (GB)

(21) Appl. No.: 14/438,455

(22) PCT Filed: Oct. 23, 2013
(86) PCT No.: PCT/US13/66441

§ 371 Date: Apr. 24, 2015

(30) Foreign Application Priority Data
Oct. 24, 2012 (GB) 1219096.3

(51) Int. Cl. H01Q 19/22; H01Q 1/38; H01Q 9/42; H01Q 1/24

(52) U.S. Cl. CPC H01Q 19/22; H01Q 1/24; H01Q 1/38; H01Q 9/42

(57) ABSTRACT

An antenna device (1) comprising a non-conductive substrate (2), wherein the antenna is in the form of a conductive pattern printed on either one or both sides of the non-conductive substrate. The conductive printed pattern includes an antenna element (5) configured for electrical connection to a coplanar groundplane (8) at a ground connection (13,13′), and further configured for electrical connection to a transmitter/receiver at a feed connection, and a passive antenna arm (115) connected to the coplanar groundplane at a passive antenna arm ground connection (116). A SAR reduction system comprising a grounded parasitic resonating conducting element is positioned on one side of the non-conductive substrate and is adapted to couple with the passive antenna arm and reduce the electromagnetic field generated by the antenna element at a predetermined frequency.

### TECHNICAL FIELD

This invention relates to a multiband antenna device configured to have a reduced Specific Absorption Rate (SAR) in one band without significantly affecting performance of the antenna device as a whole. Embodiments of the invention are particularly, but not exclusively, useful as dual- or multiband Wi-Fi antennas for portable and mobile computing platforms, tablets and smartphones.

### BACKGROUND

Modern portable computing devices such as laptop, notebook and tablet computers often have a number of antennas for communication with Wi-Fi networks, cellular radio networks and the like. An important design parameter of these antennas is the specific absorption rate (SAR). SAR is a measure of how much transmitted radio frequency (RF) electromagnetic energy is absorbed by human tissue.

An embedded antenna in a mobile or portable device may conveniently be mounted directly on the printed circuit board (PCB) used by the radio circuit, for instance, using a surface mounted technology (SMT) antenna. With such an arrangement, additional components including spring connectors or coaxial cables are unnecessary and the assembly process is simplified. However, a drawback of mounting the antenna directly on a PCB, is that it is generally necessary to create a clearance in any conductive ground layers filling the PCB in an area around the antenna. A clearance in the conductive ground layers is necessary in order to increase the operational frequency bandwidth and radiation efficiency of the antenna. However, the presence of such ground clearance can significantly increase the SAR values created by the antenna. In such an arrangement, SAR levels are elevated even when the antenna is mounted on the opposite side of the PCB from where normal contact with the human body occurs.

Reducing SAR values is important in portable computing devices because portable computing devices are often used in close proximity to the human body (for example, laptop computers when in use are often positioned on the user's lap). Devices such as portable tablet computers when in use may be positioned in the user's hands or even close to the user's head. The SAR value of a particular device is measured by averaging the RF power absorbed per unit mass of human tissue over a specific volume of tissue such as 1 g or 10 g. The units of SAR are W/kg or mW/g and the peak maximum permissible exposure (MPE) allowed for the general public is regulated by individual governments. The MPE SAR for the EU is 2.0 mW/g averaged over 10 g of tissue and the MPE SAR for the US is 1.6 mW/g averaged over 1 g of tissue.

If the SAR value for a particular device is identified as being outside these limits, then either the amount of power transmitted in the device must be reduced, or the antenna design must be changed. Minimum transmit power specifications for mobile and portable devices prevent a reduction in SAR value by simply lowering the transmitted power in the device. Therefore, alternative methods must be identified for reducing the SAR value of an antenna. The problem of elevated SAR levels is particularly acute in dual band antennas when it may be necessary to reduce the SAR of the antenna in one band without affecting the performance of the antenna in the other band. Methods of reducing SAR in portable computing devices include recessing the antenna inside the device so as to avoid immediate contact with the human body, positioning the antenna on parts of the device least likely to be in contact with human tissue, using absorbing or screening (shielding) materials, or the use of meta-materials to reduce radiation towards the human body.

There is known a method for reducing the SAR value of a mobile phone antenna at one end of a handset by introducing a parasitic monopole antenna at the opposing end of the handset (see “Parametric Study of Antenna with Parasitic Element for Improving the Hearing Aids Compatibility of Mobile Phones and the Specific Absorption Rate in the Head”, I. B. Bonev, O. Franek, and G. F. Pedersen, presented at Progress In Electromagnetics Research Symposium Proceedings, Marrakesh, Morocco, Mar. 20-23, 2011).

US 2008/254836 A1 discloses a method of reducing SAR values in a mobile communications device by positioning a metallic shielding plate at the same end of a handset as the main antenna, where the parasitic metallic plate is shorted to ground. Poutanen also discloses this method (see “Interaction between mobile terminal antenna and user”, MSc thesis, Helsinki University of Technology, 2007). It is to be appreciated that the metallic plate is effectively just a groundplane extension, albeit at the same end of the PCB as the antenna, rather than at the other end. The metallic plate is configured as a shield, and is not in any way tuned.

### BRIEF SUMMARY OF THE DISCLOSURE

Viewed from one aspect, there is provided a radio transmitting device comprising a housing and an internal driven antenna, wherein the internal driven antenna, when fed with a predetermined radio signal, generates an RF electromagnetic field having a Specific Absorption Rate (SAR) peak near the antenna when the device is in a typical usage condition in proximity of some part of a user's body, and further comprising a SAR reduction component in the form of an internal parasitic antenna within the housing that is positioned at or close to the SAR peak, wherein the parasitic antenna is tuned to generate an RF electromagnetic field having an amplitude and phase relationship with the RF electromagnetic field generated by the driven antenna resulting in a reduction in the SAR peak.

Embodiments are applicable to antennas and antenna systems with a wide variety of electrical and mechanical configurations. These include, but are not limited to, monopoles, inverted-F antennas, planar inverted-F antennas, slot antennas, notch antennas and magnetic dipole (loop) antennas. The antennas may be realised using a wide variety of fabrication methods including, but not limited to, printed circuit techniques, stamped and formed metal, and conductive elements provided with dielectric supports.

At a fundamental level, the parasitic antenna is advantageously configured as a reflector in the frequency band where any particularly undesirable SAR peak is generated by the driven antenna. It will be understood that the magnitude of the SAR will vary spatially as well as with different frequency. Accordingly, a given antenna may have first a SAR peak at a first spatial location at one frequency, and a second SAR peak at a different, second spatial location at another frequency. However, it is generally found that most well-designed radio transmitting devices tend to have a readily identifiable SAR peak in a relatively well-defined frequency band in a relatively well-defined position, although it will be appreciated that the position of the SAR peak and its frequency will need to be determined by measurement rather than being known ab initio.

The parasitic antenna is tuned by adjusting its length and shape or configuration so that it generates an RF electromagnetic field that is phase shifted, and preferably substantially in anti-phase, relative to the RF electromagnetic field generated by the driven antenna in the frequency band and the spatial position where a problematic SAR peak is determined to be present. In other words, the parasitic antenna can be configured to act as a reflector for the driven antenna, located in a spatial location where a SAR peak is determined to be present. This is an entirely different mechanism of operation from the ground patch arrangement of US 2008/254836 that is not tuned to radiate, and certainly not at a frequency and phase specially chosen to reduce the peak SAR of the driven antenna.

It is to be appreciated that the positioning of the parasitic antenna is not determined only by the location of the driven antenna, but also by the spatial location of the SAR peak at the frequency where SAR is to be reduced. While the parasitic and driven antennas may sometimes be in a facing or mutually opposed spatial relationship, other configurations may require the parasitic antenna to be located to the side of the driven antenna. Again, while the parasitic and driven antennas will often be in different planes, they may in some configurations be coplanar.

The SAR reduction component may be a bent (e.g. may be L shaped) or linear monopole-like structure, and may for example take the form of a conductive stub. Alternatively, the SAR reduction component may be configured as a small loop antenna. Other configurations are not excluded. The SAR reduction component may be printed or etched or otherwise formed on a dielectric substrate or on a host PCB. Alternatively, the SAR reduction component may be separate metal component or separate metallised plastic component.

The SAR reduction component is connected to RF ground, for example to a groundplane (either directly or by way of an impedance circuit, discussed in more detail below), and is configured and/or tuned to act as a parasitic resonator at a frequency corresponding to a predetermined peak Specific Absorption Rate frequency of the driven antenna.

Viewed from another aspect, there is provided an antenna device comprising a driven antenna comprising at least one conductive track disposed on a groundplane-free area of a host printed circuit board (PCB) dielectric substrate incorporating a conductive groundplane, wherein the driven antenna is connected to an RF feed, and further comprising a SAR reduction component in the form of a parasitic antenna that is connected to the conductive groundplane and tuned to resonate at or close to a frequency corresponding to a peak Specific Absorption Rate measurement for the driven antenna.

The driven antenna may be formed directly on the host PCB substrate, or may be formed on a separate dielectric substrate in the form of a slab or chip that is surface mounted onto the host PCB substrate in the groundplane-free area.

Multiband antennas can benefit in interesting ways from certain embodiments.

The antenna device may comprise a driven multiband antenna configured as one or more conductive tracks formed on one or both sides on a dielectric substrate, and the dielectric substrate may be surface mounted on a first surface of a printed circuit board (PCB) of a radio device.

The host PCB of the radio device has at least one conductive groundplane layer, but with the conductive groundplane layer(s) being absent from at least the area under the dielectric substrate of the driven antenna. At least one of the conductive tracks of the driven multiband antenna is connected to an RF feed. The at least one conductive track, and optionally other conductive tracks, of the multiband antenna may be connected to conductive groundplane. A SAR reduction component is provided in the form of a parasitic antenna that is connected to the conductive groundplane and tuned to resonate at or close to a frequency corresponding to a peak Specific Absorption Rate measurement for the multiband antenna.

The conductive tracks may be printed or etched or otherwise formed on the dielectric substrate in an appropriate manner. At least one of the conductive tracks may be formed as a planar inverted-F antenna (PIFA), comprising an antenna element configured for electrical connection to a coplanar groundplane at a ground connection, and further configured for electrical connection to a transmitter/receiver at a feed connection. An additional conductive track may be formed as a passive antenna arm connected to the coplanar groundplane at a passive antenna arm ground connection.

The SAR reduction component may be located on either the first surface or an opposed second surface of the PCB in the area under the dielectric substrate of the driven antenna. The SAR reduction component may be printed, etched or otherwise formed on a dielectric substrate that is surface mounted (e.g. soldered or reflowed) on the first or second surface of the PCB. Alternatively, the SAR reduction component may be formed on an undersurface of the dielectric substrate on which the driven antenna is formed before the dielectric substrate is surface mounted to the PCB. In some embodiments, the SAR reduction component may be formed on an upper surface of or incorporated in the dielectric substrate on which the driven antenna is formed. For example, the driven multiband antenna may be formed on one or two layers of a three layer dielectric substrate, and the SAR reduction component may be formed on the third layer.

It is generally preferable for the SAR reduction component to be located on a surface of the PCB opposed to the surface on which the driven antenna is mounted. This is because this is likely to correspond to a SAR peak in a direction towards a user's head or body when the radio device is being used.

While the embodiments described above can be effective in reducing the peak SAR in a given frequency band without affecting the efficiency of a multiband antenna in that band, it is possible that the SAR reduction component may affect the performance of the multiband antenna in another operating frequency band. For example, in a 2.4-2.5 GHz/4.9-5.9 GHz dual band antenna, it has been found that a conductive parasite tuned to resonate at 5.8 GHz to reduce a peak SAR at that frequency, while having little impact on antenna efficiency in that band, does reduce the efficiency of the dual band antenna in the 2.4-2.5 GHz band.

It is possible to address this problem by electrically connecting the SAR reduction component to the groundplane through an impedance circuit. The impedance circuit includes at least one capacitor and/or inductor. The at least one capacitor and/or inductor may be a lumped component or alternatively it may be a distributed component created by printing conductive tracks in an appropriate known manner on a substrate. The impedance circuit may be tuned so that the connection to the groundplane is effectively an open circuit at some frequencies and a short circuit at other frequencies. For example, the impedance circuit may be tuned to look like an open circuit in the 2.4-2.5 GHz band, and to look like a short circuit in the 4.9-5.9 GHz band. In this way, SAR reduction in the 4.9-5.9 GHz band is maintained, and efficiency in the 2.4-2.5 GHz band is substantially unaffected, since no significant current can flow in the SAR reduction component in that frequency band.

In some embodiments, the impedance circuit is electronically tuneable through the use of variable capacitors. Variable capacitors such as varicap diodes, RF microelectromechanical systems (MEMs) variable capacitors, or barium strontium titanate (BST) variable capacitors may be used to tune the impedance circuit.

In embodiments where the multiband antenna comprises a conductive track configured as a PIFA and an additional conductive track configured as a grounded passive antenna element, the SAR reduction component may be configured to couple with the passive antenna element and reduce the electromagnetic field generated by the passive antenna element at a predetermined frequency.

While a dual band Wi-Fi antenna has been used as an example in the present application, it will be understood that the invention applies equally to multiband antennas working in other frequency bands, including GSM, CDMA, WCDMA, LTE etc.

### BRIEF DESCRIPTION OF THE DRAWINGS

Embodiments of the invention are further described hereinafter with reference to the accompanying drawings, in which:

FIG. 1 is a dual band Wi-Fi antenna mounted on a host PCB;

FIG. 2 shows the measured SAR at 5.8 GHz without SAR reduction at a power level of 16 dBm;

FIG. 3 shows a dual band antenna with a SAR reduction resonator;

FIG. 4 shows the measured SAR at 5.8 GHz with the SAR reduction resonator at a power level of 16 dBm;

FIG. 5 shows the antenna efficiency in both bands before SAR reduction, with a printed SAR reduction resonator and with the resonator plus a filter circuit;

FIG. 6 shows a resonator grounded through a tuned circuit to improve the efficiency of the antenna in the lower band;

FIG. 7 shows a single band antenna mounted on a host PCB with a SAR reduction resonator;

FIG. 8 shows a schematic cross section through the embodiment of FIG. 7; and

FIG. 9 shows a schematic cross section through an alternative embodiment.

### DETAILED DESCRIPTION

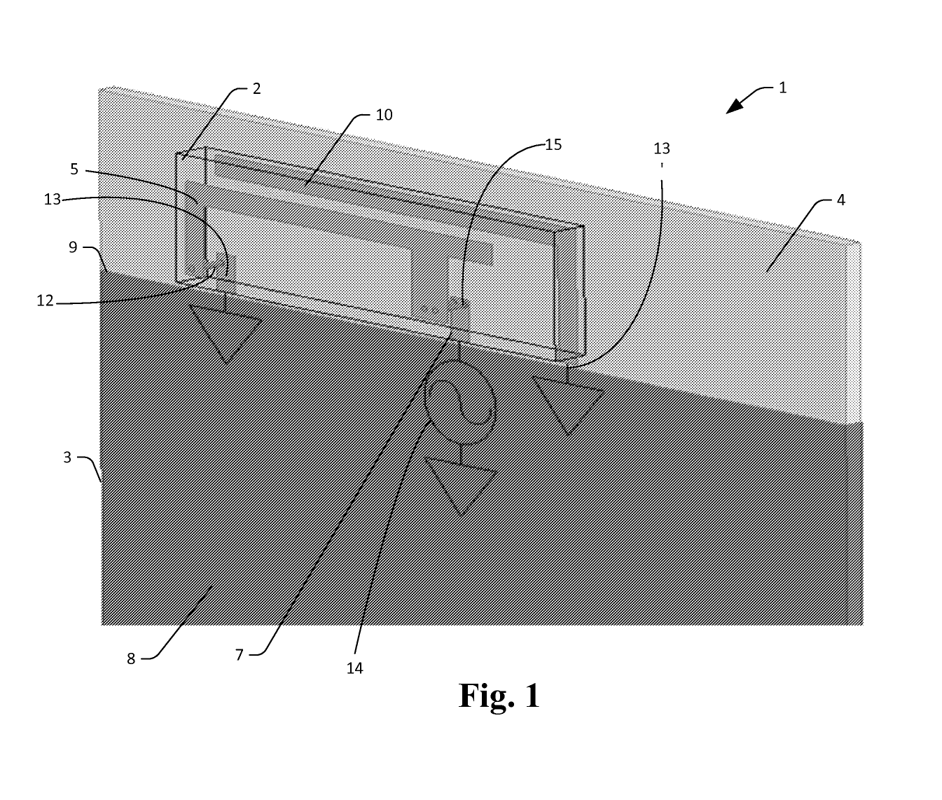

FIG. 1 shows a prior art dual band antenna device 1. The antenna device 1 includes a slab- or chip-like dielectric substrate 2 that can be surface mounted onto a groundplane-free area 4 of a host PCB 3. The host PCB 3, in addition to supporting various electronic components (not shown) of a mobile radio device, also includes a conductive groundplane 8 having an edge 9 bordering the groundplane-free area 4. The operation of this type of dual band antenna is further described, for example, in GB2487468A. The antenna device 1 includes a first conductive track 5 located on the upper surface of the antenna substrate 2 and a second conductive track 10 located on the lower surface of the antenna substrate 2. The first conductive track 5 is connected at one end to the groundplane 8 by way of a via 12 and a ground connection 13. The other end of the first conductive track 5 is connected to an RF feed 14 by way of vias 15 and a feeding connection 7. The first conductive track 5 is configured as a planar inverted-F antenna (PIFA) and acts as a driven arm of the antenna device 1. The second conductive track 10 is connected at one end to the groundplane 8 by way of a ground connection 13′, and is configured as a passive arm of the antenna device 1. The antenna substrate 2 is surface mounted onto the groundplane-free area 4 by reflowing or soldering, and is generally coplanar with or parallel to the host PCB 3. The antenna device 1 operates in the Wi-Fi bands 2.4-2.5 GHz and 4.9-5.9 GHz.

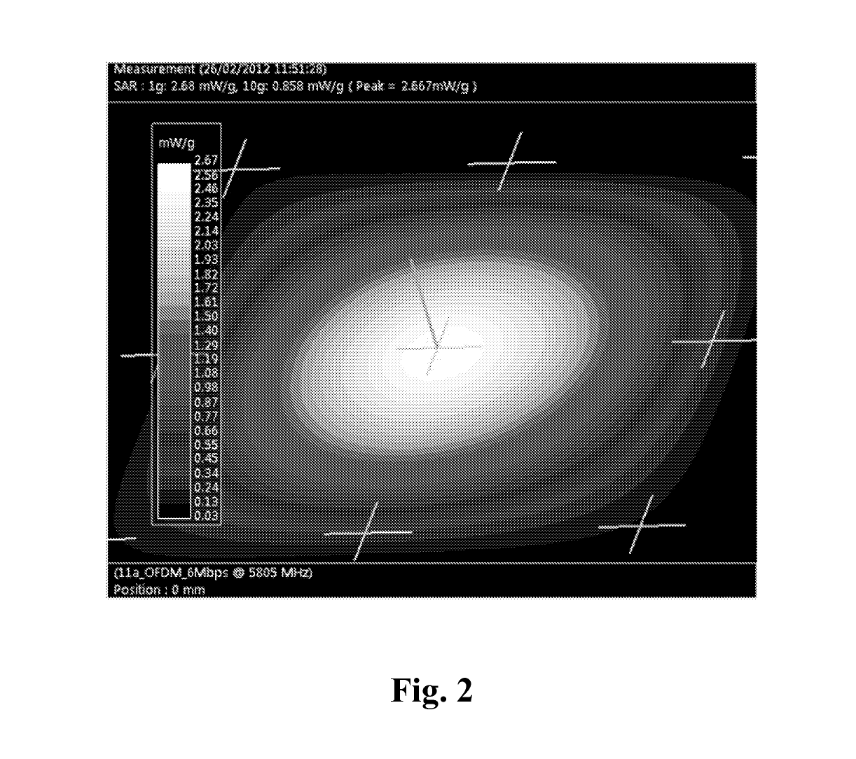

FIG. 2 shows SAR measurements of the antenna device shown in FIG. 1. Measurements were made using a Speag iSAR2 SAR testing system. The test was carried out at with an input power level of 16 dBm. The results for the 2.4 GHz low frequency band show that the measured SAR value was within the MPE limit of 1.6 mW/g. However, the plot also shows the results for the 4.9 GHz high frequency band where the SAR value is higher than the MPE limit. A ‘hotspot’ towards the centre of the antenna is also observed. The peak SAR value is around 2.7 mW/g.

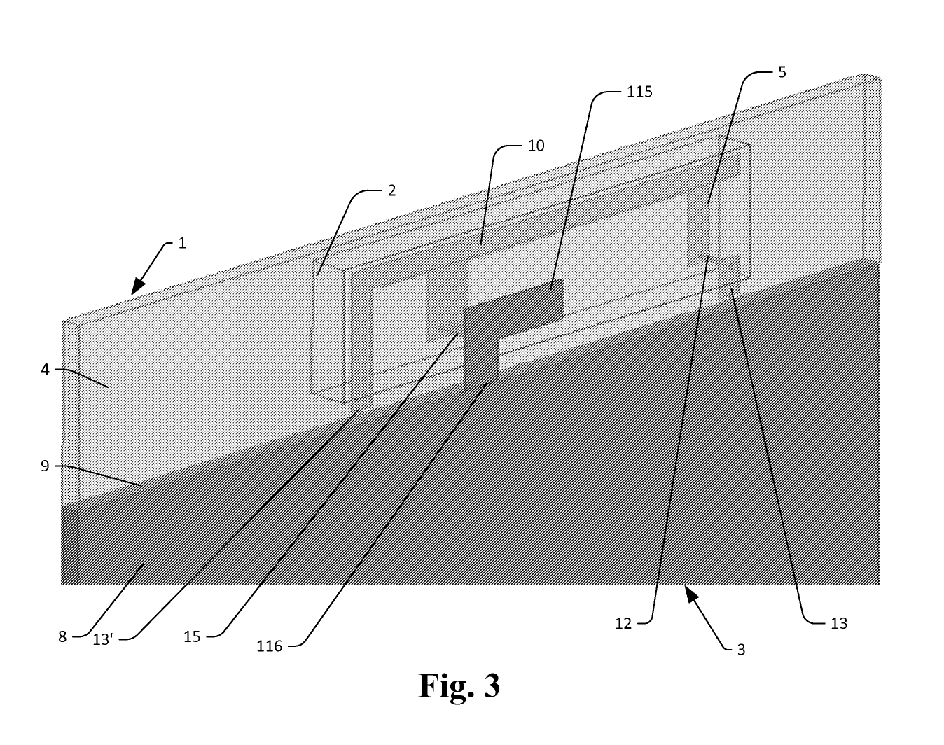

FIG. 3 shows an embodiment of the invention applied to the prior art antenna device 1 of FIG. 1, with like parts being labelled as for FIG. 1. A grounded conductive strip 115 is positioned on the surface of the host PCB 3 opposed to the surface on which the antenna substrate 2 is mounted. Typically, this surface of the host PCB will be the surface nearest to the casing of the radio communications device (e.g. a tablet computer). The conductive strip 115 is connected to the groundplane 3 by way of a ground connection 116. The conductive strip 115 is located within the area covered by the antenna substrate 2, but on the opposed surface of the host PCB 3. In the embodiment shown in FIG. 3, the conductive strip 115 has a bent, L-shape configuration, but other configurations are effective in particular applications. The conductive strip is dimensioned to resonate at 5.8 GHz, this being the frequency where the peak SAR is observed in FIG. 2.

Adding a parasitic resonating conducting element 115 (i.e. not directly connected to any radio) that resonates around the frequency at which the peak of the SAR value appears and in a location corresponding to the spatial position of the SAR peak as projected onto the host PCB 3, reduces the SAR value of the antenna device 1 without compromising the performance of the antenna in that frequency band. Such a parasitic element 115 is designed by the choice of its position, configuration and dimensions such that the RF currents are excited on it through the electromagnetic coupling with the nearby PIFA 5, and the electromagnetic field re-radiated by the parasitic SAR reduction element 115 has a phase approximately opposite to the field from the PIFA 5 in the region where the peak SAR appears. By this means, the electromagnetic field generated by the PIFA 5 is substantially reduced in the region where the peak SAR previously appeared. Since the SAR value is proportional to the square of the magnitude of the local electric or magnetic field, reducing the local electric or magnetic field reduces the peak and the average SAR value is also reduced.

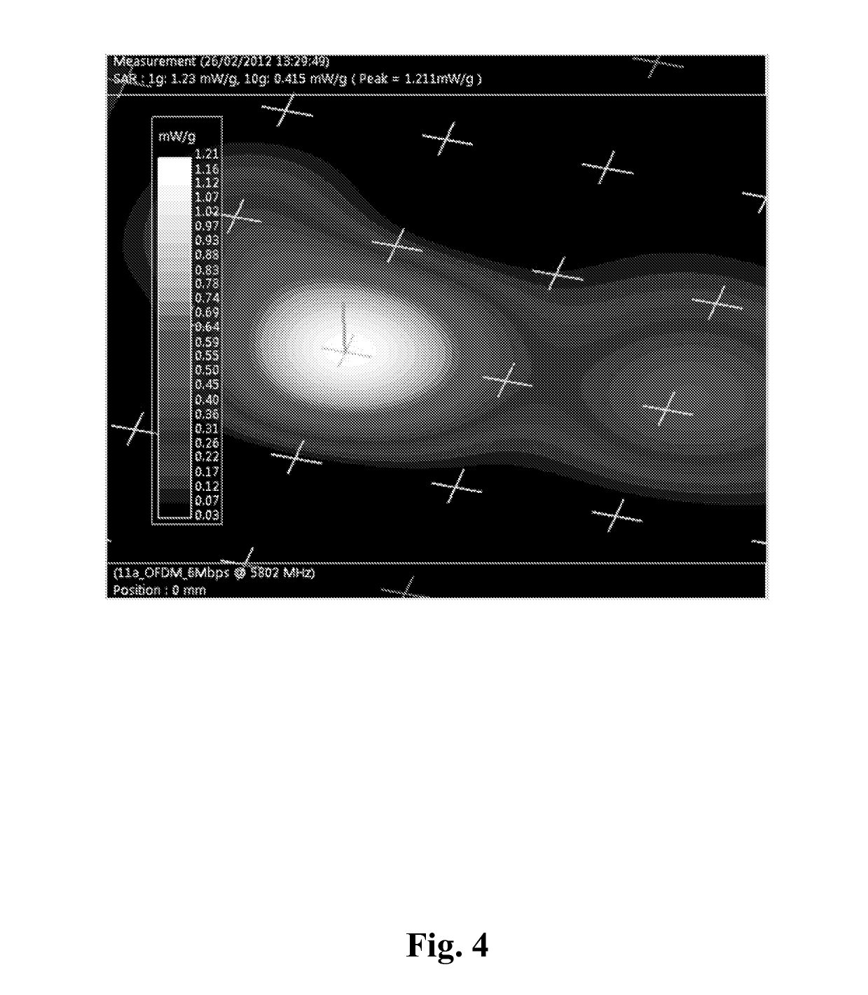

FIG. 4 shows that the addition of the parasitic resonating conducting element 115 to the antenna device 1 lowers the corresponding antenna SAR value to within the MPE limit. The peak SAR value is about 1.2 mW/g, and is therefore well below the MPE.

It is important to notice that, although the method has been illustrated with a specific type of antenna, it is applicable to many other different types of antennas that are in the form of a conductive pattern printed on one or both sides of a substrate and fixed directly to the device PCB 3 in an area 4 where the groundplane 8 is removed to allow the antenna 1 to radiate efficiently in and over the required frequency bandwidth.

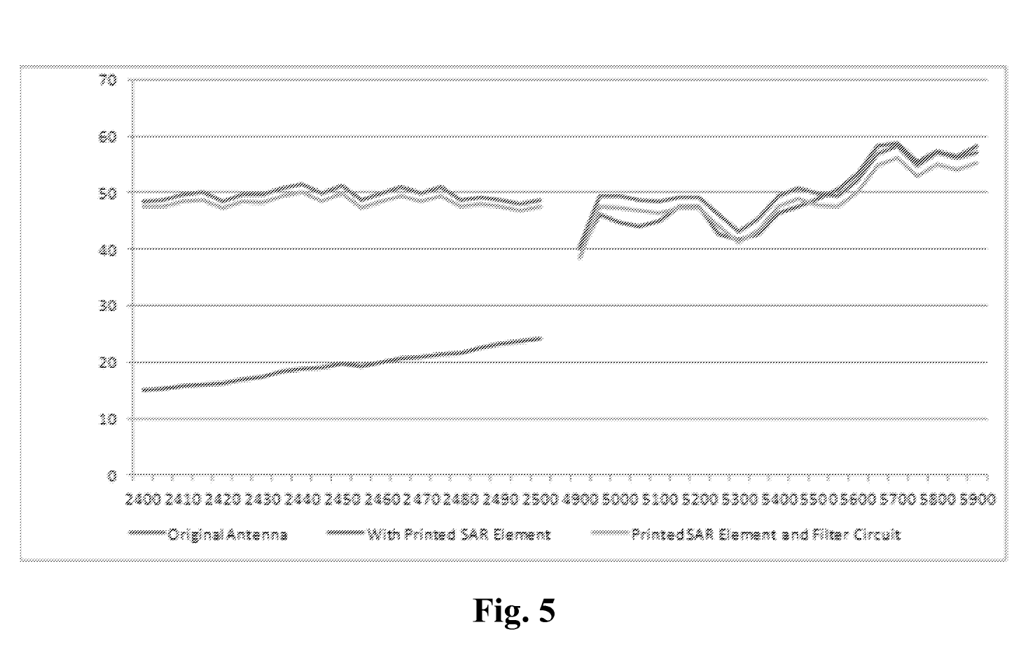

Although the method of reducing SAR illustrated is effective in reducing the peak SAR in a given frequency band without affecting the efficiency of the antenna in that band, it is possible that for a multiband antenna, the parasitic element affects the antenna performance in a different band. For instance, in the explanatory example of the dual-band Wi-Fi antenna, the resonator has the effect of reducing the antenna efficiency in the 2.4 GHz band from a mean of around 50% to about 20%. FIG. 5 shows a plot of antenna efficiency in both bands for an antenna device before the addition of a SAR reduction device, with the printed SAR reduction resonator and with the resonator plus an additional filter circuit.

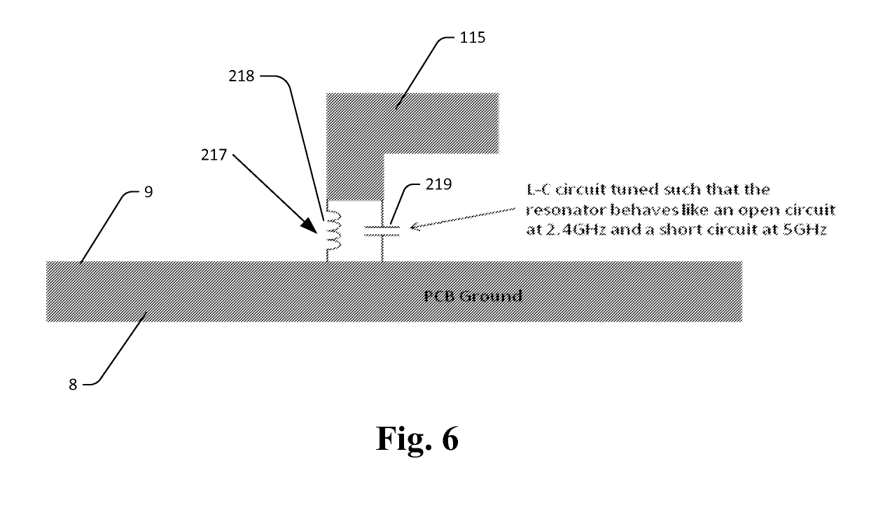

FIG. 5 shows how the efficiency of the lower band can be restored if the resonating element 115 is connected to ground through an L-C circuit 217 tuned to provide a high impedance in the 2.4 GHz band and a low impedance in the 5 GHz band. FIG. 6 shows this particular arrangement, where the conductive resonator 115 is connected to the edge 9 of the groundplane 8 by way of an impedance circuit 217 comprising an inductor 218 and a capacitor 219 tuned to look like a high impedance in the 2.4-2.5 GHz band and a low impedance in the 4.9-5.9 GHz band. In this way the SAR reduction in the 5 GHz band is maintained and the 2.4 GHz band is unaffected. This improvement in the lower band efficiency is shown in FIG. 5.

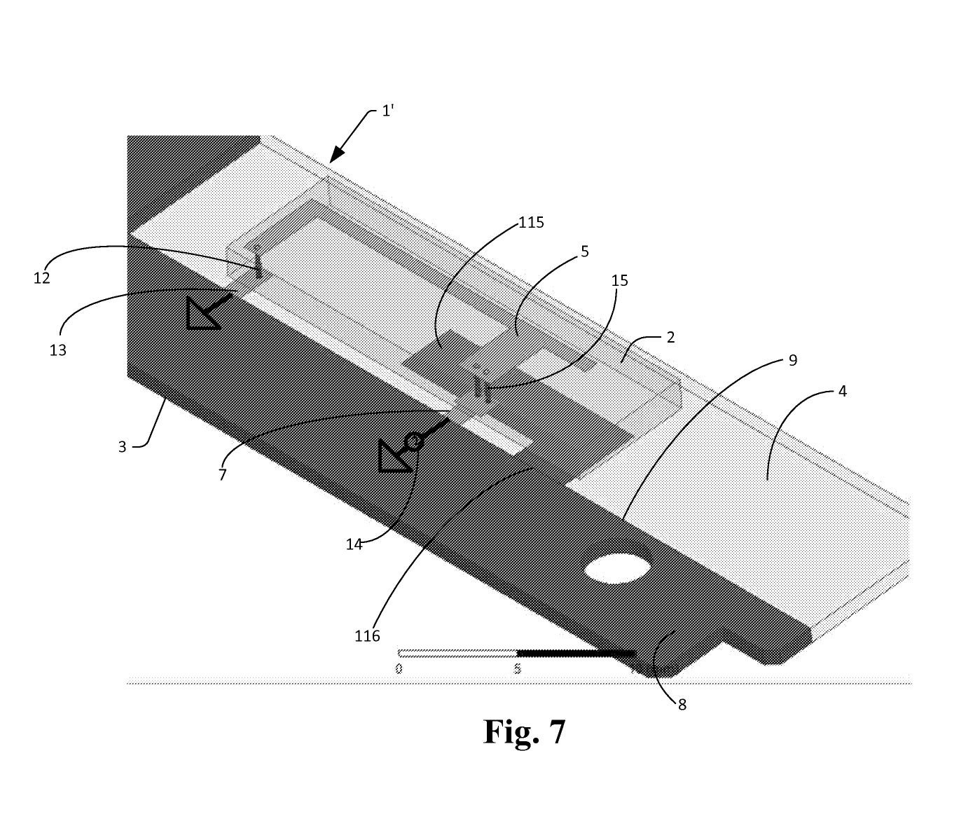

FIG. 7 shows an antenna device 1′ generally similar to that of the FIG. 3 embodiment (with like parts being labelled as for FIG. 3), but employing a single band driven PIFA antenna 5 in the form of a conductive track. The PIFA antenna 5 is formed on an upperside of a dielectric substrate 2 that is surface mounted onto an area 4 of a host PCB 3 that is free of a conductive groundplane 8 that otherwise extends over the host PCB 3. A parasitic SAR reduction element in the form of a conductive, L-shaped stub 115 is disposed on the underside of the host PCB 3 and connected to the groundplane at connection 116. It will be understood that the PIFA antenna 5 need not be formed on a separate substrate 2, but could be formed directly on the groundplane-free area 4 of the host PCB 3, with the parasitic SAR reduction element on the underside of the host PCB 3.

FIG. 8 is a schematic cross section through the embodiment of FIG. 7. The host PCB 3 in this example has two conductive groundplanes 8, one on the upperside and one on the underside. A solid dielectric substrate 2 is provided on the upperside of the host PCB 3 in the groundplane-free area 4, and the driven antenna 5 is shown on the upperside of the solid dielectric substrate 2 (position “c”). In this arrangement, the SAR reduction element is preferably provided on the underside of the solid dielectric substrate 2 (position “b”—115′) or on the underside of the host PCB 3 (position “a”—115). If the driven antenna 5 extends over both upperside and underside of the dielectric substrate 2 (positions “b” and “c”—as in the FIG. 3 embodiment), then the SAR reduction element 115 is preferably provided at position “a” on the underside of the host PCB 3.

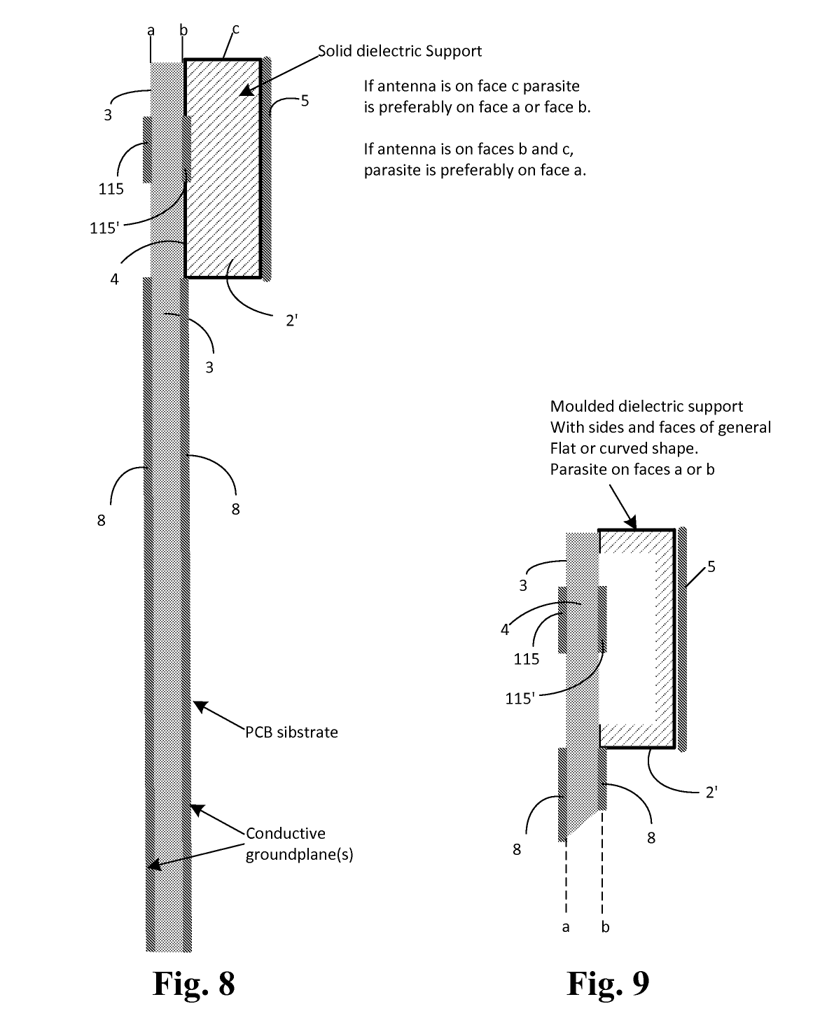

FIG. 9 is a schematic cross section through an alternative embodiment in which a moulded dielectric support 2′ is provided and used as a support for the driven antenna 5. The moulded dielectric support 2′ may have flat or curved sides and faces, and may be hollow. The parasitic SAR reduction element 115, 115′ may be provided at positions “a” or “b” (i.e. preferably not in the same plane as the driven antenna 5).

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A radio transmitting device comprising a housing and an internal driven antenna, wherein the internal driven antenna, when fed with a predetermined radio signal, generates a radio frequency (RF) electromagnetic field having a Specific Absorption Rate (SAR) peak near the antenna when the device is in a typical usage condition in proximity of some part of a user's body, and further comprising a SAR reduction component in the form of an internal parasitic antenna within the housing that is positioned at or close to the SAR peak, wherein the parasitic antenna is tuned to generate an RF electromagnetic field having an amplitude and phase relationship with the RF electromagnetic field generated by the driven antenna resulting in a reduction in the SAR peak.

2. An antenna device comprising a driven antenna comprising at least one conductive track disposed on a groundplane-free area of a host printed circuit board (PCB) dielectric substrate incorporating a conductive groundplane, wherein the driven antenna is connected to a radio frequency (RF) feed, and further comprising a Specific Absorption Rate reduction component in the form of a parasitic antenna that is connected to the conductive groundplane and tuned to resonate at or close to a frequency corresponding to a peak SAR measurement for the driven antenna.

3. The device of claim 2, wherein the driven antenna is formed on a separate dielectric substrate that is surface mounted onto the host PCB substrate in the groundplane-free area.

4. The device of claim 2, wherein the driven antenna comprises a multiband antenna configured as one or more conductive tracks formed on one or both sides on a separate dielectric substrate, and wherein the dielectric substrate is surface mounted onto the host PCB substrate in the groundplane-free area.

5. The device of any one of claims 2, wherein the SAR reduction component is printed or etched or otherwise formed on a dielectric substrate or on a host PCB.

6. The device of claim 5, wherein the impedance circuit is electronically tuneable.

7. The device of any one of claims 5, wherein the impedance circuit is configured to have a low impedance at the frequency corresponding to the peak SAR, and a high impedance at other operational frequencies of the device.

8. The device of any one of claims 2, wherein the SAR reduction component is located on a surface of the host PCB opposed to the surface on which the driven antenna is located.

9. The device of claim 8, wherein the SAR reduction component comprises a conductive track formed on a separate dielectric substrate that is surface mounted on the surface of the host PCB opposed to the surface on which the driven antenna is located.

10. The device of claim 1, wherein the SAR reduction component is not coplanar with the driven antenna.

11. The device of claim 2, wherein the SAR reduction component is not coplanar with the driven antenna.
